(19) United States
(12) Patent Application Publication
(10) Pub. No.: US 2003/0083165 A1
(43) Pub. Date: May 1, 2003

(54) Drive for a chain comprising periodically arranged chain links

(75) Inventor: Dirk Hessberger, Aachen (DE)

Correspondence Address: HENRY M FEIEREISEN, 350 FIFTH AVENUE, SUITE 3220, NEW YORK, NY, 10118, US

(73) Assignee: SCHUMAG AKTIENGESELLSCHAFT, Aachen (DE)

(21) Appl. No.: 10/233,783

(22) Filed: Sep. 3, 2002

Related U.S. Application Data
(63) Continuation of application No. PCT/DE00/03186, filed on Sep. 13, 2000.

(30) Foreign Application Priority Data
Mar. 1, 2000 (DE) 100 08 808.8

(51) Int. Cl. F16H 55/30; F16H 55/36; F16H 55/17

(52) U.S. Cl. 474/141; 74/437; 74/434; 474/152

(57) ABSTRACT

In order to provide an operationally reliable compensation in particular for polygon effects, using simple means, the invention proposes a drive to be used for a chain comprising periodically arranged chain links, the drive train of which is driven by a driving motor and has at least one non-circular wheel located on the input side.

### CROSS-REFERENCES TO RELATED APPLICATIONS

This application is a continuation of prior filed copending PCT International application no. PCT/DE00/03186, filed Sep. 13, 2000.

This application claims the priority of German Patent Application Serial No. 10O 09 808.8, filed Mar. 1, 2000, pursuant to 35 U.S.C. 119(a)-(d), the subject matter of which is incorporated herein by reference.

### BACKGROUND OF THE INVENTION

The present invention relates to a drive for a chain comprising periodically arranged chain links, in particular for a pulling machine used for pulling material to be pulled, such as bar, pipe, round and profiled stock, the drive train of which is driven by a driving motor.

In such drives, in particular in drives used for pulling machines, there is the problem of converting a rotary movement into a linear movement, in particular for pulling the material to be pulled. During this, movement artifacts might be generated which, on the one hand, are found to interfere with a synchronism of the chain, in particular also of the material to be pulled, and, on the other hand, are found to be difficult to control by the driving motor. One example of this is the polygon effect, which is described in more detail in the following, which occurs when a chain is used for pulling the material to be pulled.

Since the individual links or connecting links of a chain are rigid, the chain can only adjust to the reference circle of the chain wheel in a polygon shape. The lever arm of a force that is exerted on the chain train thus changes with the angle of rotation of the chain wheel, whereby the load moment and the advance speed of the chain that results in the direction of the chain tension vary periodically. Apart from the load and speed variations, variations of the chain at the running height are also produced, which combined might result in undesired vibrations in the machine, and thus in increased wear and tear of the entire chain drive. When designing the drive intended to be used for a chain wheel or for chain drive, this so-called polygon effect must therefore be taken into account.

To counterbalance the polygon effect, a large number of technical solutions have to date been proposed in the prior art. A compensation for the polygon effect may, for instance, be achieved by using comparatively large chain wheels comprising a large number of sprockets. Though machines having large chain wheels run comparatively steadily, this would, however, result in an increase of the construction space required for the drive, and an increase of the number of chain links or increased costs, to ensure that also the weight of the chain, and thus the drive performance to be installed, are increased.

Further, it is known from the prior art, to provide for a special chain guide mechanism as a means to compensate the polygon effect, which guide mechanism guides the chain to the chain wheel in a manner to ensure that the effect of the rigid chain links has only a reduced influence.

For instance, in chain pulling devices intended to be used for pulling solid, pipe, round, and profiled stock, hereinafter referred to as material to be pulled, using a rotating chain, the polygon effect might have considerable influence on the quality of the material to be pulled as variations in speed and vibrations directly affect the homogeneity of the pulling process, the quality of the surface of the material to be pulled, and the length tolerances of the pulled material. In a continuous pulling process, the material to be pulled is gripped with gripping tools and is pulled by the rotating driving chain pairs. Such type of continuous pulling device is, for instance, known from European Pat. No. EP 0 433 767 B1. In this chain pulling machine, no compensating device for compensating the speed variations of the driving chain that are caused by the polygon effect have been provided.

From European Pat. No. EP 0 860 216 A1, a drive intended to be used for a continuous pulling device is known, in which the polygon effect has already been taken into account. In a drive according to the generic part of the claims, a gear transmission is connected in the drive chain between the driving motor and the driven chain wheels. The drive shaft of the gear transmission is connected to the motor shaft of the driving motor via a piston crosshead joint, and is installed in a position that is swung around an angle. Owing to the piston crosshead joint, an irregularity of the circumferential speed is achieved if the drive shaft and the driven shaft are horizontally swung relative to each other, which irregularity is to be used for compensating the polygon effect. The compensating effect of such drive decisively depends on the adjustment of the angle between the drive shaft and the driven shaft. Such type of drive therefore requires, on the one hand, accurate adjustment of the angle, and, on the other hand, regular monitoring of the setting, as, if the angle is unfavorably and incorrectly adjusted, an increase of the polygon effect, rather than a compensation for it, would be achieved. The thus required construction space additionally increases costs. For practical use to achieve steady movement of a chain, in particular in a pulling device, the drive known from EP 0 860 216 A1 is therefore less suitable.

It would therefore be desirable and advantageous to provide an improved drive to obviate prior art shortcomings and to generate an operationally reliable compensation for such type of movement artifacts, in particular the polygon effect, using simple means.

### SUMMARY OF THE INVENTION

According to one aspect of the present invention, a drive train has respectively at least one non-circular wheel that is located on the input side, and at least one non-circular wheel that is located on the output side.

Selecting suitable non-circular wheels, a resulting output speed is produced on the non-circular wheel that is located on the output side, by which it is possible to completely compensate the polygon effect, so that no or only minor speed variations occur in the chain, in particular in the pulling chain train. In particular, a constant quality of the pulled material is thus ensured. With the non-circular wheels that interact with each other, and for a constant input speed of the driving motor, it is possible to adjust the output speeds of the eccentric toothed wheel located on the output side to the polygon effect. The geometries of the non-circular wheels are selected in dependence on the number of sprockets of the chain wheel, and the design of the chain links. The drive according to the invention achieves an almost complete compensation for the polygon effect, even for chain wheels comprising only a few sprockets.

To achieve a complete or at least an almost complete synchronism of the chain, it is particularly advantageous if the periodicity of the non-circular wheel located on the input side is adjusted to the periodicity of the rotating chain in a defined manner. This is achieved by the circumference of at least one of the non-circular wheels having a periodicity of a goniometric function r (φ), and such periodicity corresponding to the periodicity of the chain links. In this regard, it is obvious that corresponding gear members may be arranged in between the non-circular wheels and the chain wheel or the chain wheels, which can act on the transmission of the drive.

The invention is thus particularly suitable for pulling machines, in which the drive comprises a chain wheel having several sprockets, in particular a chain wheel of a chain puling device, which drives a preferably continuously rotating chain.

As the polygon effect occurs periodically, the non-circular wheels are preferably designed in a manner to ensure that the rolling runner of each non-circular wheel is respectively composed of several rolling circle segments with uniform rolling curve sections. The rolling curve sections of the non-circular wheel located on the input side and the non-circular wheel located on the output side should have equal rolling curve lengths, so that the rolling curve sections and thus the non-circular wheels roll steadily on each other, thus facilitating a periodic variation in the output speed of the non-circular wheel located on the output side.

It is to be understood that also a non-periodic rolling curve may be provided at the non-circular wheel, in which case the necessary periodicity is ensured by exactly one revolution of the non-circular wheel.

It is further advantageous if the non-circular wheel located on the input side has less rolling circle segments than the non-circular wheel located on the output side, so that a driving motor with high drive speeds can be used.

In a first embodiment, the number of the rolling circle segments of the non-circular wheel located on the output side corresponds to the number of sprockets. In such type of drive, the non-circular wheel located on the output side may alternatively be arranged with the chain wheel on a joint shaft, or may be coupled to the chain wheel via a toothed gearing or a transmission member, such as a toothed belt.

In an alternative embodiment, a gear transmission is positioned between the non-circular wheel on the output side and the chain wheel, and has a transmission ratio i_{K} which is defined by the ratio of the number of rolling circle segments of the non-circular wheel on the output side and the sprockets of the chain wheel, or respectively, by the ratio of the angle over which the rolling circle segments of the non-circular wheel on the output side extend, and the angular pitch of the chain wheel. Preferably, the transmission ratio is a whole number. The gear mechanism can be a single-stage or a multiple-stage intermediate gear. In particular, the transmission ratio i_{K} may integrally be divisible by the number of sprockets.

The non-circular wheel located on the output side is preferably designed in a manner to ensure that its rolling circle segments have two turning points. Thus, it is in particular possible to prevent hard shocks at the transition between rolling circle segments, or to reduce the effect of those. Preferably, the turning points are located near the minimum or the maximum radial distance. In that case, each rolling circle segment, in its center, has a minimum radial distance from the rotation axis of the non-circular wheel, and maximum radial distances from the rotation axis at the transitions to the next rolling circle segments. The distance between the rotation axes of the non-circular wheels is preferably constant.

It is further advantageous if the non-circular wheels are formed as toothed wheels, as toothed wheels facilitate secure running of the rolling circle segments on each other without the risk of any sliding in between the non-circular wheels.

In particular for chain pulling devices that are to be used to pull material having especially high quality requirements for constant thicknesses, a special chain guide mechanism for guiding the chain to the chain wheel can be provided as additional compensating means for compensating the polygon effect. In such case, the rolling curves of the non-circular wheels are adjusted according to the polygon effect that is reduced by the compensating means.

According to another aspect of the present invention, in a method for driving a chain having periodically arranged chain links, in particular of a chain drive, non-circular wheels generate a periodically variable rotation speed in a drive train, and the drive train transmits the rotation speed to a chain wheel, wherein the periodicity of the rotation speed is adjusted to the periodicity of the chain links.

Using the method according to the invention, it is possible to move a component in a steady motion, which component, due to its constructive design, could otherwise only be moved in a motion influenced by the polygon effect at high design expense.

It is obvious that, in an alternative design, the non-circular wheel located on the input side may be replaced, using corresponding means, such that the non-circular wheel located on the output side does not necessarily have to be driven by a corresponding non-circular wheel located on the input side.

It is obvious that the chain drive according to the invention can also be used for chain drives of machines or devices that are not directly used as pulling machines, in which, however, the polygon effect might have a disadvantageous effect on the steady movement of the drive of such machines or devices.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a diagrammatic view of a drive train according to the present invention without a gear transmission; and

FIG. 2 shows a drive train according to the invention with a transmission that is arranged between the non-circular wheels and the chain wheel.

### DETAILED DESCRIPTION OF PREFERRED EMBODIMENTS

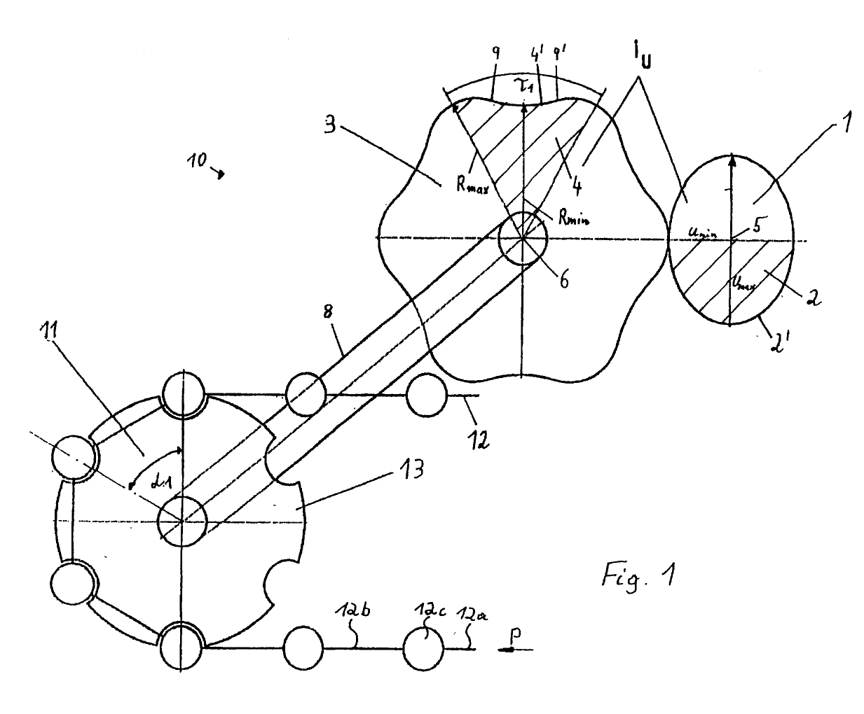

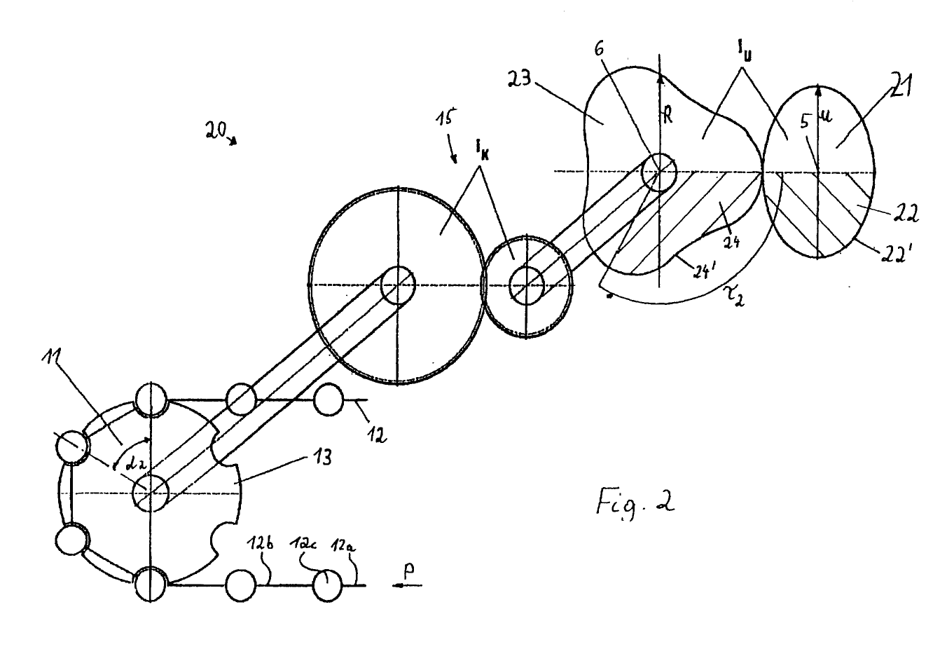

In FIGS. 1 and 2, only the components of a drive train, generally referred to as 10 in FIG. 1, or 20 in FIG. 2, respectively, that are necessary for compensating the polygon effect are represented in a merely diagrammatic representation. The drive train serves for driving chain wheel 11 of a pulling device, the other parts of which are not shown. With the chain wheel 11, a chain 12 is pulled in the direction of arrow P. The pulling chain 12 consists of chain links 12a, 12b that are flexibly connected to each other via bolt 12c, in which regard sprockets 13 of the chain wheel 11 engage in the bolt 12c. It is to be understood that it is also possible to choose a different concrete embodiment of the chain drive. To the chain 12, the gripping devices, which are not shown, for pulling the material to be pulled, which is not shown, are attached. In pulling devices, pulling of the material is usually effected using driving chain pairs, i.e. using at least two chains that run in a parallel manner to each other.

In drive train 10 in FIG. 1, a non-circular wheel 1 in the form of a gear or toothed wheel is located on the input side and connected to a driving motor (not shown) in a rotationally secure manner. In this embodiment, the non-circular wheel 1 on the input side is composed of two uniform rolling circle segments 2, one of which has been hatched in the drawing. Here, the shape slightly deviates from the ideal basic shape of an ellipse, and has been adjusted to the desired speed conditions. The non-circular wheel 1 on the input side is in mesh via its teeth (not shown) with the teeth of a non-circular gear wheel 3 on the output side. The non-circular wheel 3 has a total of 6 rolling circle segments 4 that are uniform in respect to each other, one of which has been hatched in the drawing.

It is to be understood that the individual non-circular wheels may be composed of or manufactured from one piece, and that the term rolling circle segments only refers to the uniform structure of individual non-circular wheels.

The rolling circle segment 2 of the non-circular wheel 1 has a rolling curve section 2′ that has the same arc length or rolling curve length as rolling curve section 4′ of rolling circle segment 4 of the non-circular wheel 3 on the output side. Furthermore, the distance between rotation axis 5 of the non-circular wheel 1 and rotation axis 6 of the non-circular wheel 3 is constant. The rolling curve or the circumference of the non-circular wheel 3 can therefore be determined from the constant total of the generatrix radius R of the non-circular wheel 3 and the generatrix radius U of the non-circular wheel 1.

To compensate the polygon effect that occurs during operation of the drive train 10 at the chain wheel 11, the rolling curve section 4′ of the rolling circle segment 4 of the non-circular wheel located on the output side 3 has two turning points 9, 9′, as well as a rolling curve point having a minimum radial distance Rₘᵢₙ in the center of the rolling curve section 4′, and two rolling curve points having a maximum radial distance Rₘₐₓ. In this regard, the position of the turning points is not represented in the correct scale in the drawing. The non-circular wheel 1 has been placed in mesh with the non-circular wheel 3 in a way that, on the one hand, the rolling curves contact each other when the minimum radial distance of the non-circular wheel 1 Uₘᵢₙ coincides with the maximum radial distance Rₘₐₓ of the non-circular wheel 3, and, on the other hand, they contact each other when the maximum radial distance of the non-circular wheel 1 Uₘₐₓ coincides with the minimum radial distance Rₘᵢₙ. The speed of the non-circular wheel 3 on the output side is minimal when, as shown in FIG. 1, the minimum radial distance Uₘᵢₙ and the maximum radial distance Rₘₐₓ coincide, or, respectively, maximal when the maximum radial distance Uₘₐₓ and the minimum radial distance Rₘᵢₙ coincide. For compensating purposes, the coupling of the non-circular wheel 3 on the output side to the chain wheel 11 is now executed in such a way that the speed of the non-circular wheel 3 on the output side has a minimum value when, as shown in FIG. 1, the chain wheel 11 is in angular position in which, for a theoretically constant driving speed of the chain wheel 11, a maximum chain advance speed in direction p would result due to the polygon effect. In fact, however, due to the non-circular wheels 1, 3 that mate with each other, the driving speed of the non-circular wheel 3 on the output side is just minimal, so that, in total, the polygon effect and the speed variations generated with the non-circular wheels 1, 3 neutralize one another, resulting in an absolutely steady chain pulling speed in direction p.

It is now apparent to those skilled in the art what generatrix radii and arc radii the maximum radii, minimum radii, and the turning points of the rolling curves or the non-circular wheels 1, 3 must have in order to achieve optimum compensation for the polygon effect for a certain chain wheel.

In FIG. 1, the transmission ratio between the non-circular wheel 3 and the non-circular wheel 1 is iᵤ=3:1. The non-circular wheel 3 on the output side is connected to the chain wheel 11 via a transmission member 8. Therefore, the angle τ₁, over which the rolling circle segment 4 of the second non-circular wheel 3 extends, must have the same size as angle α₁ deep in between two sprockets 13 of the chain wheel 11. Instead of the transmission member, it is, however, also possible to use a toothed gearing, or to arrange the non-circular gear wheel and the chain wheel on a joint shaft.

FIG. 2 shows an alternative embodiment of a drive train 20. Parts corresponding with those in FIG. 1 are denoted by identical reference numerals. Here as well, the chain 12 is moved by means of the sprockets 13 of the chain wheel 11 in transport direction p. In deviation from the embodiment according to FIG. 1, the non-circular wheel 23 located on the output side is coupled to the chain wheel 11 via a gear transmission that is generally referred to by reference numeral 15. The gear transmission 15 is composed, in manner principally known, of sprockets, belts, chains, or the like, and can be designed as a single-stage or multiple-stage gear. Here, the non-circular wheel 23 on the output side has only 3 rolling circle segments 24 with rolling curve sections 24′, which extend over angular area τ₂. The gear transmission 15 has a transmission ratio of i_{K}=τ₂/α₂. Thus, the chain wheel 11 rotates around the angle α₂ when the non-circular wheel 23 located on the output side rotates around the angle τ₂. Though the non-circular wheel located on the input side 21 that is coupled to the driving motor, which is not shown, is designed in an almost elliptic shape, as in the embodiment according to FIG. 1, and comprises two rolling circle segments 22, the dimensions of the principal and the secondary axes, or the generatrix radius U of the non-circular wheel 21, are adjusted to the changed curve geometry of the rolling circle segment 24.

It is to be understood for both embodiments that the transmission ratio iᵤ existing between the non-circular wheels can comparatively freely be selected so that, in general, the drive can very flexibly be adjusted to the optimum motor speed of the driving motor. For a chain wheel having a different number of sprockets or a different diameter, different rolling curves and generatrix radii are required for the non-circular wheels to compensate the polygon effect.

While the invention has been illustrated and described in connection with preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

1. A drive for a chain comprising periodically arranged chain links the drive train of which is driven by a driving motor, wherein the drive train has at least one non-circular wheel located on an input side and at least one non-circular wheel located on an output side.

2. The drive of claim 1, wherein the chain is a pulling drive of a pulling machine for pulling material to be pulled.

3. The drive of claim 2, wherein the pulling material is a member selected from the group consisting of bar, pipe, round stock, and profiled stock.

4. The drive of claim 1, wherein the non-circular wheel is defined by a circumference which has a periodicity of a goniometric function r (φ), wherein the periodicity corresponds to a periodicity of the chain links.

5. The drive of claim 1, wherein the drive comprises a chain wheel having several sprockets and driving a chain.

6. The drive of claim 5, wherein the chain wheel is part of a chain pulling device.

7. The drive of claim 5, wherein the chain is a continuously rotating chain.

8. The drive of claim 1, wherein the non-circular wheel on the input side has rolling curve sections and the non-circular wheel on the output side has rolling curve sections which have a same rolling curve length as the rolling curve sections of the non-circular wheel on the input side.

9. The drive of claim 1, wherein the non-circular wheel on the input side has fewer rolling circle segments than the non-circular wheel on the output side.

10. The drive of claim 5, wherein the non-circular wheel on the output side has rolling circle segments at a number which corresponds to a number of the chain sprockets.

11. The drive of claim 10, wherein the non-circular wheel on the output side and the chain wheel are arranged on a joint shaft.

12. The drive of claim 10, wherein the non-circular wheel on the output side and the chain wheel are coupled to each other via a member selected from the group consisting of toothed gearing and transmission member.

13. The drive of claim 12, wherein the transmission member is a belt.

14. The drive of claim 10, and further comprising a gear transmission positioned between the non-circular wheel on the output side and the chain wheel, said gear transmission having a transmission ratio defined by an angular area of the rolling circle segments of the non-circular wheel on the output side and the angular pitch of the chain wheel.

15. The drive of claim 14, wherein the transmission ratio is a whole number.

16. The drive of claim 14, wherein the gear transmission is a single-stage or a multiple-stage intermediate gear mechanism.

17. The drive of claim 8, wherein the rolling curve sections of rolling circle segments of the non-circular wheel on the output side have two turning points.

18. The drive of claim 1, wherein the non-circular wheels are defined by rotation axes spaced form one another by a constant distance.

19. The drive of claim 1, wherein that the non-circular wheels are toothed wheels.

20. The drive of claim 5, wherein the chain is guided to the chain wheel by a special chain guide mechanism.

21. A method for driving a chain having periodically arranged chain links, in particular of a chain drive, wherein non-circular wheels generate a periodically variable rotation speed in a drive train, and the drive train transmits the rotation speed to a chain wheel, wherein the periodicity of the rotation speed is adjusted to the periodicity of the chain links.
